(19) United States
(12) Patent Application Publication
(10) Pub. No.: US 2005/0170830 A1
(43) Pub. Date: Aug. 4, 2005

(54) Link adaptation in a mobile communication network

(76) Inventors: Kent Pedersen, Frederiksberg (DK); Benoist Sebire, Beijing (CN)

Correspondence Address: PERMAN & GREEN, 425 POST ROAD, FAIRFIELD, CT, 06824, US

(21) Appl. No.: 10/766,970

(22) Filed: Jan. 29, 2004

(51) Int. Cl. H04Q 7/20

(52) U.S. Cl. 455/432.1; 455/67.11

(57) ABSTRACT

In order to effect link adaptation in a mobile communication network employing the parallel transmission of a plurality of transport channels, transport format combination commands and link quality reports are carried in transport channels which may be dedicated to these functions.

### FIELD OF THE INVENTION

The present invention relates to link adaptation in a radio communication system.

### BACKGROUND OF THE INVENTION

Link adaptation is an efficient mean for providing the best suitable channel coding for a given radio link. Link adaptation is utilized both for packet switched channels in GPRS/EGPRS and for circuit switched speech channels in AMR. However, it has not been implemented in a system in which a plurality of transport channels are transmitted in parallel.

### SUMMARY OF THE INVENTION

According to a first aspect of the present invention, there is provided a method of controlling the operation of a mobile communication network mobile station, the method comprising transmitting a transport format combination command signal to a mobile station in a transport channel, wherein said transport channel is combined with and transmitted with at least one other transport channel.

According to the first aspect of the present invention, there is also provided a mobile communication network infrastructure apparatus comprising processing means and transmitter means, wherein the processing means is configured for generating a transport format combination command signal, processing the transport format combination command signal in a transport channel, combining said transport channel with at least one other transport channel to produce a combined signal and supplying the combined signal to the transmitter means for transmission to a mobile station.

It may be that only commands are carried in the transport channel carrying the transport format combination command signal.

A received signal quality report may be received from the mobile station and the transport format combination command signal may be generated in dependence on the received signal quality report.

According to a second aspect of the present invention, there is provided a method of operating a mobile station in a mobile communications network, the method comprising receiving a transport format combination command in a transport channel and using the transport format combination commanded by said command for a subsequent transmission of speech and/or data signals.

According to the second aspect of the present invention, there is also provided a mobile station for a mobile communications network, the mobile station comprising processing means and transceiving means, wherein the processing means is configured for using a transport format combination, specified in a transport channel received by the receiving means, for subsequent transmission of speech and/or data signals.

The quality of a received downlink signal may be determined and a report of said quality transmitted in a transport channel. Said transport channel may be combined with and transmitted with at least one other transport channel. The report may represent bit error predictions or bit error rates. These rates may be mapped onto block codes for transmission.

According to a third aspect of the present invention, there is provided a method of operating a mobile communication network, the method comprising:
transmitting a transport format combination command signal to a mobile station in a transport channel, said transport channel being combined with and transmitted with at least one other transport channel; and
receiving said transport format combination command at a mobile station and using the transport format combination commanded by said command for a subsequent transmission of speech and/or data signals by the mobile station.

According to the third aspect of the present invention, there is also provided a mobile communication network including:
an infrastructure apparatus comprising:
   processing means and transmitter means, the processing means being configured for generating a transport format combination command signal, processing the transport format combination command signal in a transport channel, combining said transport channel with at least one other transport channel to produce a combined signal and supplying the combined signal to the transmitter means for transmission to a mobile station, and
a mobile station comprising:
   processing means and transceiving means, the processing means being configured for using a transport format combination, specified in a transport channel received by the receiving means from said infrastructure apparatus, for subsequent transmission of speech and/or data signals.

The infrastructure apparatuses mentioned above may be base transceiver stations, base station controller or the like. The apparatuses may be implemented by combinations of base transceiver stations and base station controllers, or the like.

### BRIEF DESCRIPTION OF THE DRAWINGS

FIG. 1 shows a mobile communication system according to the present invention;

FIG. 2 is a block diagram of a mobile station;

FIG. 3 is a block diagram of a base transceiver station;

FIG. 4 illustrates the frame structure;

FIG. 5 illustrates a packet data channel;

FIG. 6 illustrates the sharing of a radio channel between two half-rate packet channels;

FIG. 7 illustrates the lower levels of a protocol stack;

FIG. 8 is a block diagram illustrating downlink processing at a base transceiver station;

FIG. 9 is a block diagram illustrating uplink processing at a base transceiver station;

FIG. 10 is a block diagram illustrating downlink processing in a mobile station; and

FIG. 11 is a block diagram illustrating uplink processing in a mobile station.

### DETAILED DESCRIPTION OF EMBODIMENTS

Embodiments of the present invention will now be described, by way of example, with reference to the accompanying drawings.

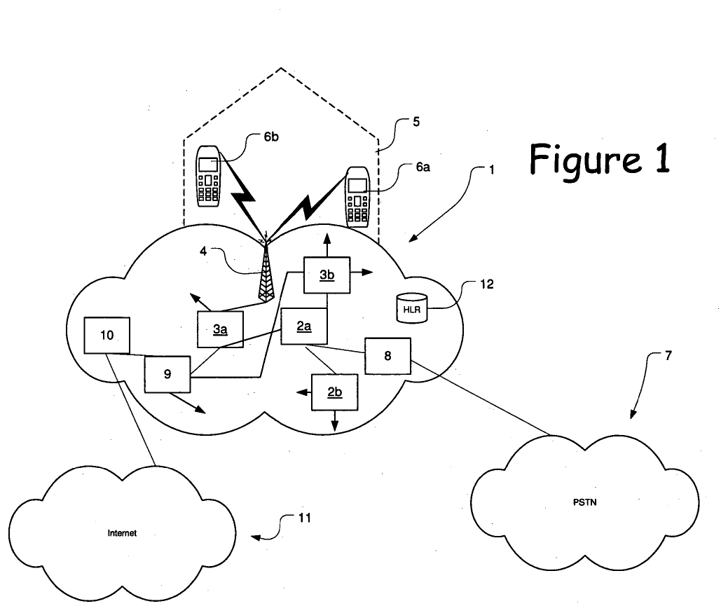

Referring to FIG. 1, a mobile phone network 1 comprises a plurality of switching centres including first and second switching centres 2a, 2b. The first switching centre 2a is connected to a plurality of base station controllers including first and second base station controllers 3a, 3b. The second switching centre 2b is similarly connected to a plurality of base station controllers (not shown).

The first base station controller 3a is connected to and controls a base transceiver station 4 and a plurality of other base transceiver stations. The second base station controller 3b is similarly connected to and controls a plurality of base transceiver stations (not shown).

In the present example, each base transceiver station services a respective cell. Thus, the base transceiver station 4 services a cell 5. However, a plurality of cells may be serviced by one base transceiver station by means of directional antennas. A plurality of mobile stations 6a, 6b are located in the cell 5. It will be appreciated what the number and identities of mobile stations in any given cell will vary with time.

The mobile phone network 1 is connected to a public switched telephone network 7 by a gateway switching centre 8.

A packet service aspect of the network includes a plurality of packet service support nodes (one shown) 9 which are connected to respective pluralities of base station controllers 3a, 3b. At least one packet service support gateway node 10 connects the or each packet service support node 10 to the Internet 11.

The switching centres 3a, 3b and the packet service support nodes 9 have access to a home location register 12.

Communication between the mobile stations 6a, 6b and the base transceiver station 4 employs a time-division multiple access (TDMA) scheme.

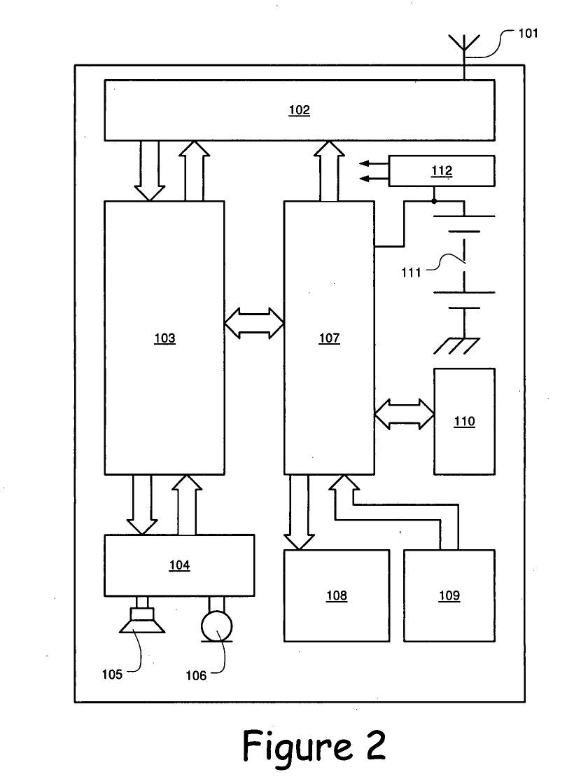

Referring to FIG. 2, the first mobile station 6a comprises an antenna 101, an rf subsystem 102, a baseband DSP (digital signal processing) subsystem 103, an analogue audio subsystem 104, a loudspeaker 105, a microphone 106, a controller 107, a liquid crystal display 108, a keypad 109, memory 110, a battery 111 and a power supply circuit 112.

The rf subsystem 102 contains if and rf circuits of the mobile telephone's transmitter and receiver and a frequency synthesizer for tuning the mobile station's transmitter and receiver. The antenna 101 is coupled to the rf subsystem 102 for the reception and transmission of radio waves.

The baseband DSP subsystem 103 is coupled to the rf subsystem 102 to receive baseband signals therefrom and for sending baseband modulation signals thereto. The baseband DSP subsystems 103 includes codec functions which are well-known in the art.

The analogue audio subsystem 104 is coupled to the baseband DSP subsystem 103 and receives demodulated audio therefrom. The analogue audio subsystem 104 amplifies the demodulated audio and applies it to the loudspeaker 105. Acoustic signals, detected by the microphone 106, are pre-amplified by the analogue audio subsystem 103 and sent to the baseband DSP subsystem 104 for coding.

The controller 107 controls the operation of the mobile telephone. It is coupled to the rf subsystem 102 for supplying tuning instructions to the frequency synthesizer and to the baseband DSP subsystem 103 for supplying control data and management data for transmission. The controller 107 operates according to a program stored in the memory 110. The memory 110 is shown separately from the controller 107. However, it may be integrated with the controller 107.

The display device 108 is connected to the controller 107 for receiving control data and the keypad 109 is connected to the controller 107 for supplying user input data signals thereto.

The battery 111 is connected to the power supply circuit 112 which provides regulated power at the various voltages used by the components of the mobile telephone.

The controller 107 is programmed to control the mobile station for speech and data communication and with application programs, e.g. a WAP browser, which make use of the mobile station's data communication capabilities.

The second mobile station 6b is similarly configured.

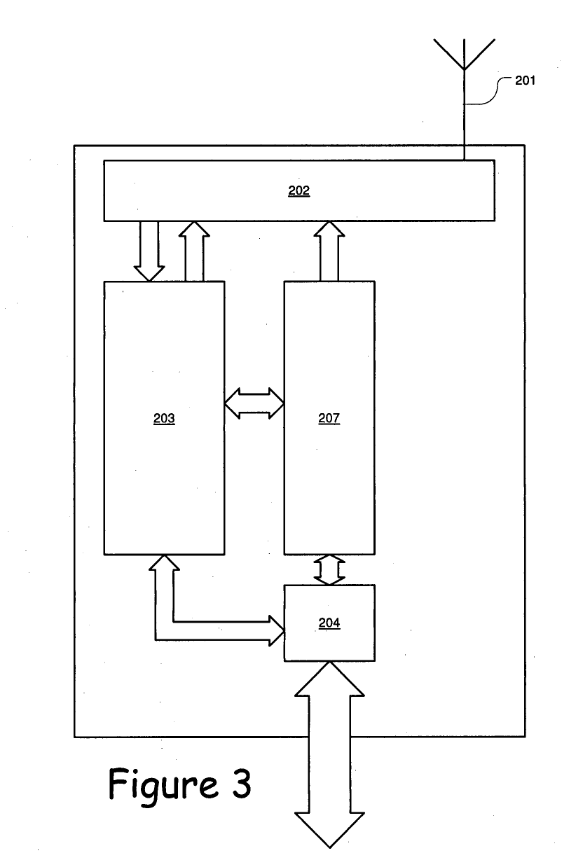

Referring to FIG. 3, greatly simplified, the base transceiver station 4 comprises an antenna 201, an rf subsystem 202, a baseband DSP (digital signal processing) subsystem 203, a base station controller interface 204 and a controller 207.

The rf subsystem 202 contains the if and rf circuits of the base transceiver station's transmitter and receiver and a frequency synthesizer for tuning the base transceiver station's transmitter and receiver. The antenna 201 is coupled to the rf subsystem 202 for the reception and transmission of radio waves.

The baseband DSP subsystem 203 is coupled to the rf subsystem 202 to receive baseband signals therefrom and for sending baseband modulation signals thereto. The baseband DSP subsystems 203 includes codec functions which are well-known in the art.

The base station controller interface 204 interfaces the base transceiver station 4 to its controlling base station controller 3a.

The controller 207 controls the operation of the base transceiver station 4. It is coupled to the rf subsystem 202 for supplying tuning instructions to the frequency synthesizer and to the baseband DSP subsystem for supplying control data and management data for transmission. The controller 207 operates according to a program stored in the memory 210.

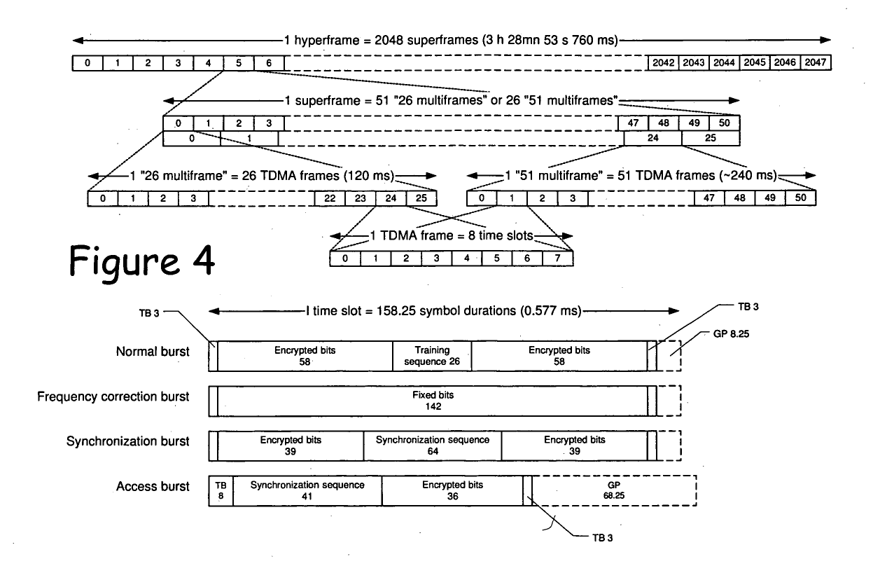

Referring to FIG. 4, each TDMA frame, used for communication between the mobile stations 6a, 6b and the base transceiver stations 4, comprises eight 0.577 ms time slots. A “26 multiframe” comprises 26 frames and a “51 multiframe” comprises 51 frames. Fifty one “26 multiframes” or twenty six “51 multiframes” make up one superframe. Finally, a hyperframe comprises 2048 superframes.

The data format within the time slots varies according to the function of a time slot. A normal burst, i.e. time slot, comprises three tail bits, followed by 58 encrypted data bits, a 26-bit training sequence, another sequence of 58 encrypted data bits and a further three tail bits. A guard period of eight and a quarter bit durations is provided at the end of the burst. A frequency correction burst has the same tail bits and guard period. However, its payload comprises a fixed 142 bit sequence. A synchronization burst is similar to the normal burst except that the encrypted data is reduced to two clocks of 39 bits and the training sequence is replaced by a 64-bit synchronization sequence. Finally, an access burst comprises eight initial tail bits, followed by a 41-bit synchronization sequence, 36 bits of encrypted data and three more tail bits. In this case, the guard period is 68.25 bits long.

When used for circuit-switched speech traffic, the channelisation scheme is as employed in GSM.

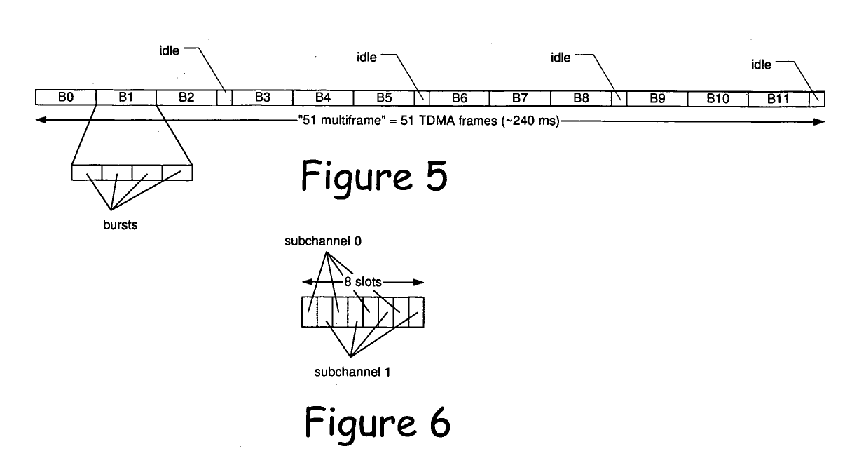

Referring to FIG. 5, full rate packet switched channels make use of 12 4-slot radio blocks spread over a “51 multiframe”. Idle slots follow the third, sixth, ninth and twelfth radio blocks.

Referring to FIG. 6, for half rate, packet switched channels, both dedicated and shared, slots are allocated alternately to two sub-channels.

The baseband DSP subsystems 103, 203 and controllers 107, 207 of the mobile stations 6a, 6b and the base transceiver stations 4 are configured to implement two protocol stacks. The first protocol stack is for circuit switched traffic and is substantially the same as employed in conventional GSM systems. The second protocol stack is for packet switched traffic.

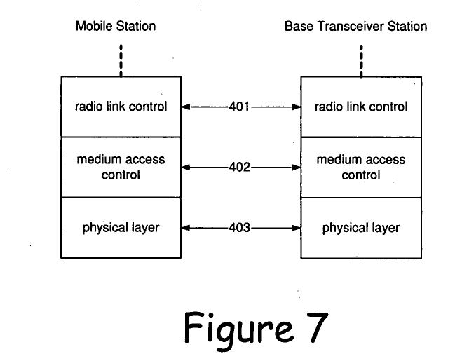

Referring to FIG. 7, the layers relevant to the radio link between a mobile station 6a, 6b and a base transceiver station 4 are the radio link control layer 401, the medium access control layer 402 and the physical layer 403.

The radio link control layer 401 has two modes: transparent and non-transparent. In transparent mode, data is merely passed up or down through the radio link control layer without modification.

In non-transparent mode, the radio link control layer 401 provides link adaptation and constructs data blocks from data units received from higher levels by segmenting or concatenating the data units as necessary and performs the reciprocal process for data being passed up the stack. It is also responsible for detecting lost data blocks or reordering data block for upward transfer of their contents, depending on whether acknowledged mode is being used. This layer may also provide backward error correction in acknowledged mode.

The medium access control layer 402 is responsible for allocating data blocks from the radio link control layer 401 to appropriate transport channels and passing received radio blocks from transport channels to the radio link control layer 403.

The physical layer 403 is responsible to creating transmitted radio signals from the data passing through the transport channels and passing received data up through the correct transport channel to the medium access control layer 402.

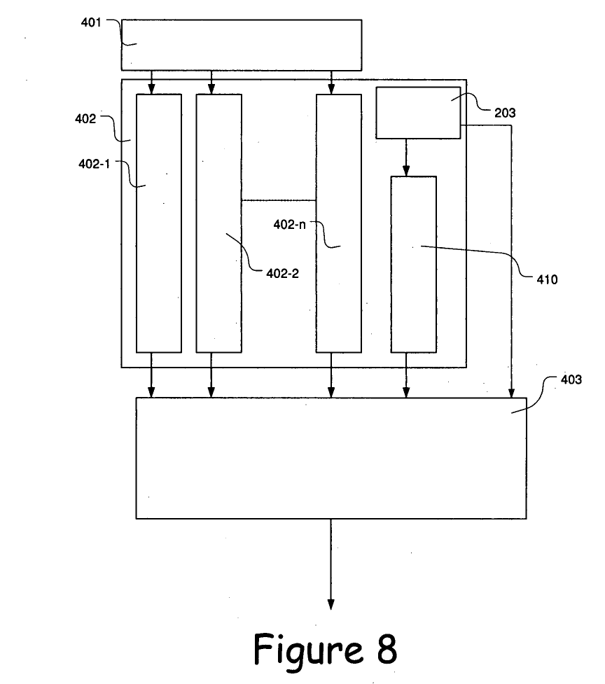

Referring to FIG. 8, in a base transceiver station 4 downlink data streams are received from the radio link control layer 401. These data streams may comprise speech or data, which may come from a plurality of different sources. The data streams are allocated to different transport channels 402-1, 402-2, . . . , 402-n in the medium access layer 402. The transport channels are processed according to different formats which are allocated on the basis of the characteristics of the data streams and the quality of the physical channel to the receiving mobile station 6a, 6b. An additional transport channel 410 carries control information from the base transceiver station's controller 203.

The transport channels 402-1, 402-2, . . . , 402-n, 410 are multiplexed and interleaved and formed into radio link packets in the physical layer 403. The controller 203 also provides a transport format combination indicator (TFCI) to physical layer where it is included in the radio link packets in predetermined locations. The TFCI informs the receiving mobile station 6a, 6b of the formats of the transport channels so that the appropriate de-interleaving, decoding etc. can be performed.

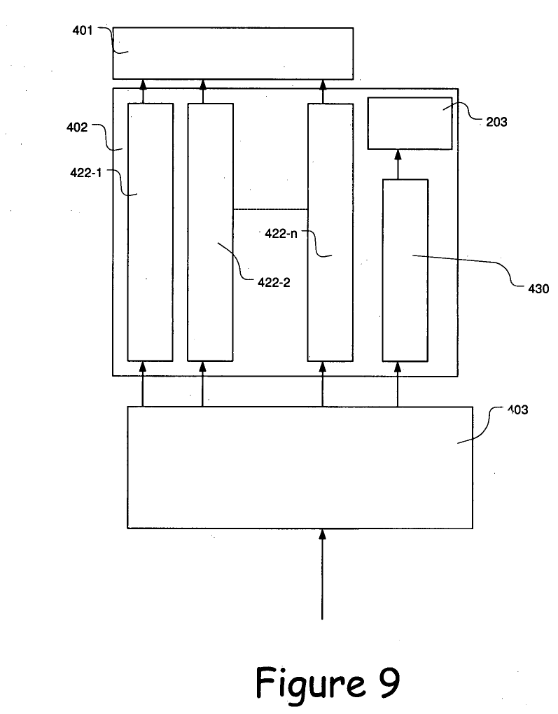

Referring to FIG. 9, uplink signals received by the rf subsystem 202 from a mobile station 6a, 6b are de-interleaved and demultiplexed in the physical layer 403 and divided among a plurality of transport channels 422-1, 422-2, . . . , 422-n, 430 according to the extant transport format combination. One of the transport channels 430 carries control information which is provided to the base transceiver station's controller 203. The other transport channels carry speech or data and are processed to provide decoded data streams to the radio link control layer 401 for routing to their respective destinations.

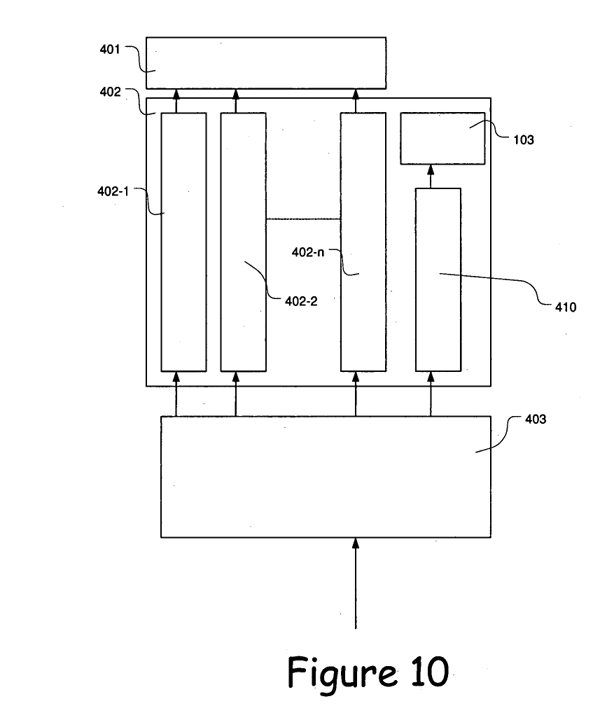

Referring to FIG. 10, in a mobile station 6a, 6b, downlink signals received by its rf subsystem 102 are de-interleaved and demultiplexed in the physical layer 403 and divided among a plurality of transport channels 402-1, 402-2, . . . , 402-n, 410 according to a transport format combination indicator carried by the packets from the base transceiver station 4. One of the transport channels 410 carries control information which is provided to the mobile station's controller 203. The other transport channels carry speech or data and are processed to provide decoded data streams to the radio link control layer 401 for processing by the relevant higher level programs.

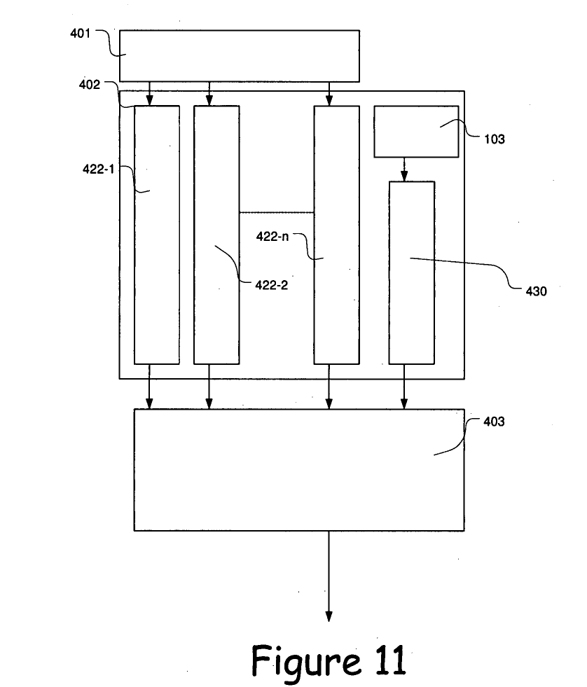

Referring to FIG. 11, in a mobile station 6a, 6b, the uplink data streams are received from the radio link control layer 401. These data streams may comprise speech or data, which may come from a plurality of different higher level programs. The data streams are allocated to different transport channels 422-1, 422-2, . . . , 422-n in the medium access layer 402. The transport channels are processed according to different formats which are allocated on the basis of the characteristics of the data streams and the quality of the physical channel to the base transceiver station 4 with which the mobile station 6a, 6b is communicating. An additional transport channel 430 carries control information from the mobile station's controller 103.

The transport channels 422-1, 422-2, . . . , 422-n, 430 are multiplexed and interleaved and formed into radio link packets in the physical layer 403.

The control transport channels 410, 430 are configured during call setup. The base transceiver station 4 initially sends a transport format combination to the mobile station 6a, 6b in the downlink control transport channel 410. The mobile station 6a, 6b uses the transport format combination from the beginning of the next transmission time interval until it receives a new transport format combination in the downlink control transport channel 410. The signal quality reports are based on bit error rate or bit error probability before decoding, making the reporting media codec agnostic.

In order to limit the size of the commands and messages in the control transport channels 410, 430 and provide sufficient protection of the contents, they are coded using a block code having a maximum coded length of 36 symbols.

During a call, the transport format combination to be used in the downlink is decided at the base transceiver station 4, on the basis of the signal quality reports received from the mobile station 6a, 6b. Since, a transport format combination indicator is included in the downlink signal in predetermined locations, a mobile station 6a, 6b always knows the formats used by the current block. Consequently, the base transceiver station 4 can change the downlink transport format combination at any time.

When a mobile station 6a, 6b receives a block that contains the downlink transport channel 410, as specified at call setup, it decodes the block using the specified block code to extract the transport format combination that is to be used in the uplink from the next transmission time interval onwards.

When the base transceiver station 4 receives a control transport channel block from the mobile station 6a, 6b, it decodes the information using the specified block code to extract a code representing the downlink signal quality, i.e. link quality, in terms of a bit error probability (BEP) or a bit error rate (BER).

The mobile stations 6a, 6b may determine the signal quality by processing one or more received transport channel signals to generating a received signal quality signal in dependence on the quality of the or each transport channel signal prior to channel decoding. Alternatively, the received undecoded transport format combination indicator or the packet training sequences may be used for generating the link quality message.

The coding of the link quality involves quantizing the BEP or BER such that error rates of 50% plus are allocated the highest value and the lowest value indicates a rate of 0%. Since, a 36 bit codeword is used, the message will have an accuracy of 36 values between 0 and 50%, for instance 50/36% per step with a linear scale. The codeword size and coding used are the same as those used for transport format combination indicators.

Shorter or longer codewords may be used for the link quality reporting codes.

An alternative to the use of dedicated transport channels is to include the transport format combination instruction and the link quality reports in a speech transport channel together with speech data.

It is to be understood that the foregoing embodiments are merely examples and that many modifications are possible without departing from the spirit and scope of the appended claims.

1. A method of controlling the operation of a mobile communication network mobile station, the method comprising transmitting a transport format combination command signal to a mobile station in a transport channel, wherein said transport channel is combined with and transmitted with at least one other transport channel.

2. A method according to claim 1, wherein only commands are carried in the transport channel carrying the transport format combination command signal.

3. A method according to claim 2, including receiving a received signal quality report from said mobile station and generating the transport format combination command signal in dependence on the received signal quality report.

4. A mobile communication network infrastructure apparatus comprising processing means and transmitter means, wherein the processing means is configured for generating a transport format combination command signal, processing the transport format combination command signal in a transport channel, combining said transport channel with at least one other transport channel to produce a combined signal and supplying the combined signal to the transmitter means for transmission to a mobile station.

5. An apparatus according to claim 4, wherein the processing means is configured such that only commands are carried in the transport channel carrying the transport format combination command signal.

6. An apparatus according to claim 5, including receiving means for receiving a received signal quality report from a mobile station, wherein the processing means is configured for generating a transport format combination command signal for said mobile station in dependence on the received signal quality report.

7. A method of operating a mobile station in a mobile communications network, the method comprising receiving a transport format combination command in a transport channel and using the transport format combination commanded by said command for a subsequent transmission of speech and/or data signals.

8. A method according to claim 7, including determining the quality of a received downlink signal and transmitting a report of said quality in a transport channel, wherein said transport channel is combined with and transmitted with at least one other transport channel.

9. A mobile station for a mobile communications network, the mobile station comprising processing means and transceiving means, wherein the processing means is configured for using a transport format combination, specified in a transport channel received by the receiving means, for subsequent transmission of speech and/or data signals.

10. A mobile station according to claim 9, wherein the processing means is configured for determining the quality of a downlink signal received by the transceiving means, supplying an indication of said quality to a transport channel, combining said transport channel with at least one other transport channel to produce a combined signal and causing the transceiving means to transmit said combined signal.

11. A method of operating a mobile communication network, the method comprising:
transmitting a transport format combination command signal to a mobile station in a transport channel, said transport channel being combined with and transmitted with at least one other transport channel; and
receiving said transport format combination command at a mobile station and using the transport format combination commanded by said command for a subsequent transmission of speech and/or data signals by the mobile station.

12. A method according to claim 11, wherein only commands are carried in the transport channel carrying the transport format combination command signal.

13. A method according to claim 11, including determining the quality of a received downlink signal at the mobile station and transmitting a report of said quality in a transport channel, wherein said transport channel is combined with and transmitted with at least one other transport channel.

14. A method according to claim 13, including receiving a received signal quality report from said mobile station and generating the transport format combination command signal in dependence on the received signal quality report.

16. A mobile communication network including:
an infrastructure apparatus comprising:
processing means and transmitter means, the processing means being configured for generating a transport format combination command signal, processing the transport format combination command signal in a transport channel, combining said transport channel with at least one other transport channel to produce a combined signal and supplying the combined signal to the transmitter means for transmission to a mobile station, and
a mobile station comprising:
processing means and transceiving means, the processing means being configured for using a transport format combination, specified in a transport channel received by the receiving means from said infrastructure apparatus, for subsequent transmission of speech and/or data signals.

17. A network according to claim 16, wherein the processing means of the infrastructure apparatus is configured such that only commands are carried in the transport channel carrying the transport format combination command signal.

18. A network according to claim 16, wherein the processing means of the mobile station is configured for determining the quality of a downlink signal received by the transceiving means from the infrastructure apparatus, supplying an indication of said quality to a transport channel, combining said transport channel with at least one other transport channel to produce a combined signal and causing the transceiving means to transmit said combined signal to the infrastructure apparatus.

19. A network according to claim 18, wherein the infrastructure apparatus includes receiving means for receiving a received signal quality report from the mobile station and the processing means of the infrastructure apparatus is configured for generating a transport format combination command signal for said mobile station in dependence on the received signal quality report.
